(19) United States
(12) Patent Application Publication
(10) Pub. No.: US 2024/0286456 A1
(43) Pub. Date: Aug. 29, 2024

(54) Device for using the HVAC system of a vehicle

(71) Applicant: StromGold Outdoor AB, ÖRNSKÖLDSVIK (SE)

(72) Inventors: John INGOLD, ÖRNSKÖLDSVIK (SE); Anders NILVIUS, VÄRNAMO (SE)

(21) Appl. No.: 18/443,325

(22) Filed: Feb. 16, 2024

(30) Foreign Application Priority Data
Feb. 24, 2023 (SE) 2350208-1
Feb. 24, 2023 (SE) 2350209-9

(51) Int. Cl. B60H 1/26

(52) U.S. Cl. CPC B60H 1/267

(57) ABSTRACT

A device comprising, an inlet configured to attach to a HVAC outlet in a cabin of a vehicle, a closing plate configured to be arranged in an opening from a cabin of the vehicle to the exterior of the vehicle, and an air conduit from the inlet trough an aperture in the closing plate, to a device outlet.

### FIELD OF THE INVENTION

This invention relates to a device for providing heating or cooling to a living space, for example a tent, from a vehicle or a boat that is equipped with an HVAC system.

### BACKGROUND

Camping in hot or cold climates may be uncomfortable because it is difficult to control the climate in a tent or a weekend cabin. Hence, there is a need for a way to provide heating or cooling to living spaces. The various embodiments of this invention solve this and other problems.

### SUMMARY OF THE INVENTION

In a first aspect of the invention there is provided a device comprising, an inlet configured to attach to a HVAC outlet in a cabin of a vehicle a closing plate configured to be arranged in an opening from a cabin of the vehicle to the exterior of the vehicle and an air conduit from the inlet trough an aperture in the closing plate, to a device outlet.

This makes it possible to provide heating or cooling from the vehicle to a living space without rain, snow, or insects entering the cabin. Coupling the living space directly to the HVAC device provides more efficient heating or cooling.

The inlet may be configured to reversibly or removably attach to the HVAC outlet with a snap fit, friction fit, or an interference fit.

The air conduit may comprise a first conduit part from the inlet to the closing plate and a second conduit part from the closing plate to the device outlet, and the first or second conduit part may be rotatably attached to the closing plate.

The conduit comprises a first conduit part from the inlet to the closing plate and a second conduit part from the closing plate to the device outlet and the first or second conduit part may be reversibly or removably attached to the closing plate. This has the advantage of avoiding kinks in the air conduit.

In one embodiment closing plate has a first side and a second side, where the closing plate is configured to be arranged in an opening from a cabin of the vehicle to the exterior of the vehicle, said opening having a lower end defined by a lower edge, the lower edge being a part of the vehicle, and where the closing plate has a lower edge configured to be arranged along the lower edge of the opening and characterized in that the lower edge of the closing plate has a flange with an outer surface that is continuous with the surface of the second side of the closing plate, said flange being configured to cover a part of the exterior of the vehicle.

The flange may be configured to lead water away from the surface of the second side of the closing plate and onto the exterior of the vehicle.

A part of the lower edge may have a downward-facing groove arranged to receive the lower edge of the opening of the vehicle, where the flange forms a part of the groove.

In a second aspect of the invention there is provided a method for providing heating or cooling to a living space using a device according to the first aspect of the invention, the method involving a vehicle with a cabin and a HVAC system for providing heated or cooled air to the cabin the cabin having an opening to the exterior, said HVAC system having at least one HVAC outlet,
the method comprising the steps of
arranging the closing plate in the opening,
connecting the inlet to a HVAC outlet,
providing the device outlet to the living space, and
running the HVAC system of the vehicle to provide heated or cooled air to the living space.

When the HVAC system of the vehicle has a plurality of HVAC outlets and where the HVAC system may be adjusted so that heated or cooled air is provided only from the HVAC outlet to which the inlet is connected.

The vehicle is may be an electric vehicle.

In a third aspect of the invention there is provided a device comprising a closing plate configured to be arranged in an opening from a cabin of the vehicle to the exterior of the vehicle
an air conduit from an aperture in the closing plate where the conduit is rotatably attached to the closing plate.

### DRAWINGS

The accompanying drawings form a part of the specification and schematically illustrate preferred embodiments of the invention and serve to illustrate the principles of the invention.

FIG. 1 shows a device and a vehicle, in accordance with some embodiments.

FIG. 2 shows a device, in accordance with some embodiments.

FIG. 3 shows a device with a partial section along line A-A in FIG. 2, in accordance with some embodiments.

FIG. 4 shows an inlet of the device arranged in a vehicle, in accordance with some embodiments.

FIG. 5 shows an inlet arranged in a vehicle, in accordance with some embodiments, where the HVAC system is schematically shown.

FIGS. 6-7 shows an inlet, in accordance with some embodiments.

FIG. 8 is a partial section of a device and a part of a vehicle, in accordance with some embodiments.

FIG. 9-11 shows a device and parts thereof, in accordance with some embodiments.

### DETAILED DESCRIPTION

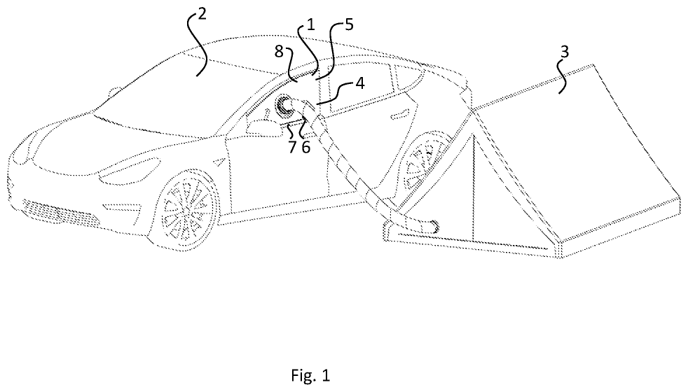

FIG. 1 shows one embodiment of a device 1 being used together with a vehicle 2. However, the device 1 may be used with any type of vehicle 2 or boat that has a cabin with a HVAC system 12, where the HVAC system 12 can provide cooled or heated air to the cabin.

The device 1 is provided separately from the vehicle 2. The device 1 is configured to be reversibly or removably attached to the vehicle 2, preferably in a temporary manner.

FIG. 1 shows how the device 1 provides a flow of heated or cooled air to a living space 3. The living space 3 is outside the cabin of the vehicle 2. The living space 3 may be any type of living space 3 that may need heating or cooling for example a camping tent, a camping trailer, or a weekend house (weekend cabin). For example, when camping in a hot climate, cooled air can be provide from the car to a tent. A different example is when someone travels with a car to a weekend house in the winter. A weekend house will often stay unheated in the weekdays, even if the weekend cabin has some kind of heater, in order to save electricity. When a user travels to the weekend house in the weekend it will take some time to heat the cabin. By using the device 1, the weekend cabin can be heated much faster. The device 1 may also be used for various types of military living spaces such as tents.

The vehicle 2 may be any type of suitable vehicle 2, such as a car (automobile), such as a four- or five seated car, a pickup, or a van. The vehicle 2 typically has four wheels. The vehicle 2 has a cabin, which is a space can be closed off and where people can stay. The cabin of the vehicle 2 can typically be closed in a manner that keeps rain, snow, and insects out.

Embodiments of the invention will be described below in relation to a vehicle 2, but it should be realized that embodiments of the invention can also be used on a boat, where the boat has a cabin. The boat may be a boat intended for recreation.

The cabin has an opening 4 to the exterior. The opening 4 may be a window that can be opened but may also be a hatch. An example of a hatch is the hatch of the Rivian R1T. The opening 4 of the vehicle 2 can be closed with a window, typically a glass pane, or a hatch that is provided as a part of the vehicle 2.

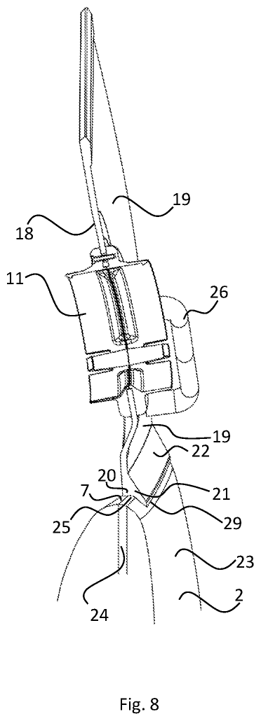

The opening 4 may be a car window that can be opened to some extent, for example the side window on the driver's side or the passenger side of a car. Such windows can typically be opened by lowering the glass pane, such that the glass pane at least partially, or completely, disappears into the car door, typically into windowpane slot 24 (see FIG. 8). The use of device 1 together with such a window is seen in FIG. 1. However, in some embodiments the window may be a glass pane that slides sideways.

In a preferred embodiment, the vehicle 2 an electric vehicle 2, that is, a vehicle 2 that is powered by a battery, meaning that a battery is able to power propulsion. Examples of such vehicles include Tesla Model S, Tesla Model 3, Tesla Model X, Tesla Model Y, Tesla Cybertruck, Kia EV6, Kia Niro EV, Ford Mustang Mach-e, Rivian R1S, Rivian R1T, Ford F-150 Lightning. The HVAC system 12 of the vehicle 2 is preferably powered by a battery of the vehicle 2.

The opening 4 of the vehicle 2 may have an upper end 5 and a lower end 6. The lower end 6 defines a lower edge 7 which is a part of the vehicle 2. However, in some embodiments, the opening 4 may be a horizontal opening where no upper or lower end can be defined.

The device 1 comprises a closing plate 8 which is configured to be arranged in the opening 4 of the vehicle 2.

The closing plate 8 may be made from any suitable material which may be plastic, such as for example a polymer material such as polymethylmethacrylate, polyurethane, ABS, PP, PA Plastics, EPDM Rubber, TPE, or glass.

When the closing plate 8 is configured to be arranged in a window opening it may be referred to as a “window closing plate 8”.

The closing plate 8 is shaped to provide closing of opening 4 in a manner that prevents rain, snow, and insects from entering the cabin of the vehicle 2. Hence, when the closing plate 8 is arranged in the opening 4, it may provide a closed space. The closing plate 8 will typically be configured to interact with a specific model or make of a car such as for example Tesla Model S, or Tesla Model 3, in order to provide a snug fit.

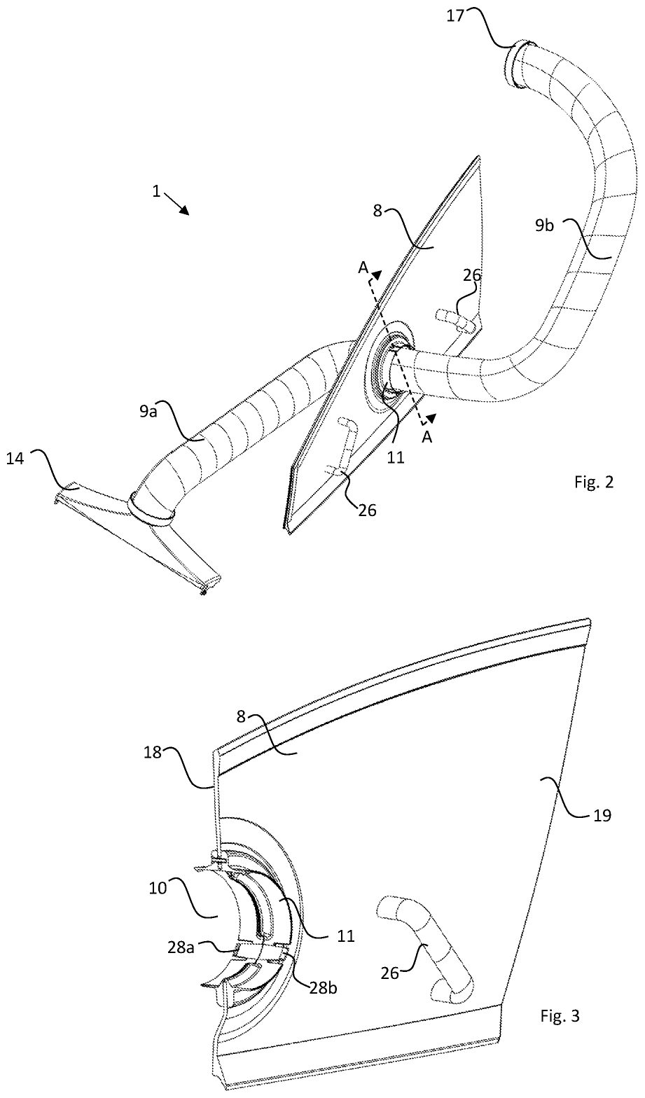

As shown in FIGS. 2 and 3, the device 1 comprises closing plate 8, air conduit 9 which may comprise first and second conduit parts 9a and 9b, or may be one single conduit 9. In some embodiments, air conduit 9 may be made from one single conduit or hose that passes through the aperture 10. In embodiments that have two conduit parts, one conduit part 9a connects the inlet 14 to the aperture 10 and one conduit 9b leads from the aperture 10 to the device outlet 17. The conduit 9 may be for example a flexible air hose, for example of a flexible polymer material with steel spring reinforcement. The conduit, for example, the air hose, may have any suitable diameter, for example from 5 cm to 25 cm. The conduit can have a circular cross section.

The closing plate 8 has a first side 18 and a second side 19. The first side 18 may be an inner side and the second side 19 may be an outer side, meaning that the closing plate 8 is configured to be arranged in a certain direction in the opening 4, where the first side 18 of the closing plate 8 is facing the cabin is the inner side and the second side 19 of the closing plate is the outer side. For example, the second side may have a flange 21 as described herein. The first side 18 may be slightly concave. Second side 19 may be slightly convex.

The length of the part of the conduit 9 that goes from the second side 19 of the closing plate 8 to the device outlet 17 may have any suitable length in order to reach living space 3 such as for example from 1.5 meters to 20 meters.

The closing plate 8 has an aperture 10 from the first side 18 and the second side 19. In FIGS. 2 and 3 the aperture 10 is associated with an optional attachment device, which may be arranged as a sleeve 11, for first and second conduit parts 9a and 9b. The attachment device may, in some embodiments, be used to reversibly or removably attach first and second conduit parts 9a, 9b in a convenient manner. Conduit parts 9a, 9b may for example attach to attachment device with a snap fit, a force fit, or a friction fit. This makes it convenient to disassemble and store the device 1. Hence device 1 may have a sleeve 11 that is at least partly arranged in aperture 10 and which is configured to reversibly attach first or second conduit parts 9a, 9b or both. The sleeve 11 may be attached to the window closing plate 8.

In FIGS. 1 and 2 the aperture 10 is arranged roughly in the middle of the closing plate 8 but the aperture 10 may also be arranged in, for example, the corner of the closing plate 8. The aperture 10 has an area that is smaller than area of the opening 4 of the vehicle 2. In various embodiments, the area of the opening 4 is at least double, such as at least three times the area of the aperture 10, such as at least four times of the area of the aperture 10.

In FIG. 2 the device 1 comprises optional one or more handles 26 which makes installing the device 1 in the vehicle 2 convenient. The handle 26 may, for example, be arranged on the second side 19 of the closing plate 8.

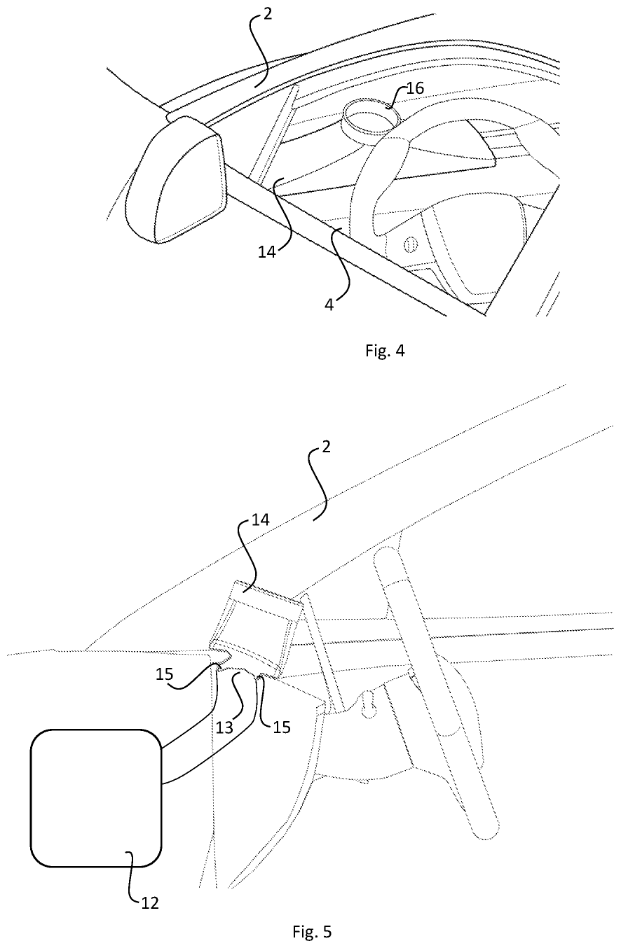

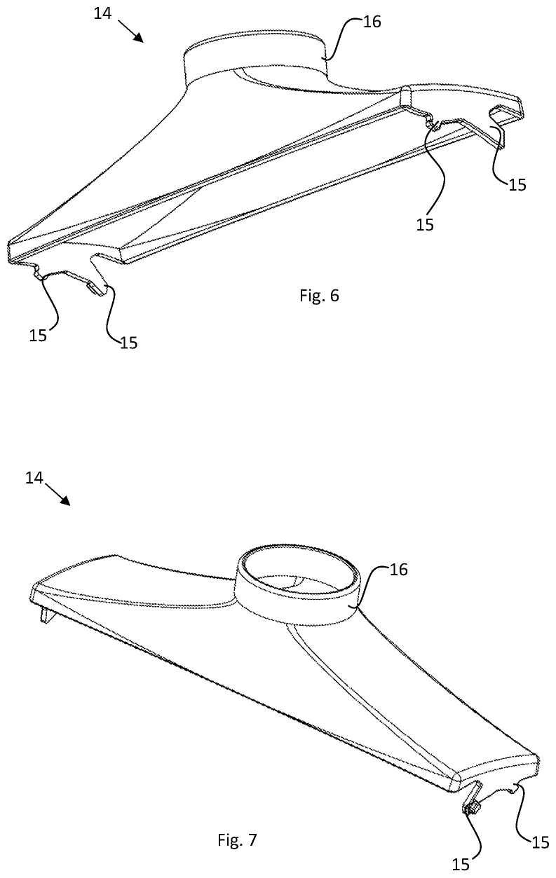

HVAC system 12 of the vehicle 2 has one or more HVAC outlets 13 for providing heated or cooled air as is known in the art. A user is typically able to control the HVAC system 12. For example, a user may be able to select a set temperature, controlling fan speed, etc. The device 1 comprises an inlet 14, or inlet device 14, which is configured to attach to a HVAC outlet 13 inside the cabin. The inlet 14 is able to connect reversibly to the HVAC outlet 13. HVAC outlets 13 of vehicles have a wide range of shapes, depending on the model of the vehicle 2. For example, the HVAC outlet 13 may be shaped as a nozzle or as a slot in the dashboard as seen in FIGS. 4-5. The inlet 14 may be configured to reversibly or removably attach to the HVAC outlet 13, for example with a snap fit, friction fit or an interference fit. The inlet 14 may for example have teeth or claws 15 that are configured to interact with the shape of an HVAC outlet 13. The teeth or claws 15 may be flexible in order to provide a snap fit. As shown in FIGS. 5 to 7, the inlet 14 has flexible claws 15 that interact parts of the HVAC outlet 13. The inlet 14 is designed to interact with a specific HVAC outlet of a specific vehicle car model and the inlet 14 of FIGS. 4-7 is configured to interact with an HVAC outlet 13 of a Tesla Model 3.

The inlet 14 may be made from any suitable material in particular a polymer material such as ABS or polyurethane.

The inlet 14 may have suitable rubber strips or brush strips that line the circumference of the inlet 14 in order to provide an airtight or semi-airtight seal or generally to direct a stream of air from HVAC outlet 13 into conduit 9 via inlet 14. The inlet 14 may have a sleeve 16 for connecting to conduit 9, for example a hose. The inlet 14 is configured to receive air stream from the HVAC outlet 13. The inlet 14 may, in various embodiments, be configured to direct at least 80%, such as at least 90% or such as at least 95%, of the air flow from the HVAC outlet 13 into the conduit 9.

The conduit 9 has a device outlet 17, which in some embodiments is an end of a hose that forms conduit 9. In some embodiments device outlet 17 may have some kind of connector device for connection to the living space 3. However, when the living space 3 is a tent the device outlet 17 may simply be arranged, by the user, in an opening of the tent in a suitable manner.

Hence, the inlet 14 is arranged to attach to a HVAC outlet 13 of the HVAC system 12 of a vehicle 2 such that a flow of air can be provided to the device outlet 17 of the air conduit 9.

As shown in FIG. 8, in various embodiments the closing plate 8 may be configured to be arranged in an opening 4 which has lower end 6 which may be defined by a lower edge 7 of the opening 4, the lower edge 7 being a part of the vehicle 2 (such as a for example a door of the vehicle 2), and where the closing plate 8 has a lower edge 20 configured to be arranged along the lower edge 7 of the opening 4 and where the lower edge 20 of the closing plate 8 has a flange 21 with an outer surface 22 that is continuous with the surface of the second side 19 of the closing plate 8, said flange 21 being configured to cover at least a part of the exterior 23 of the vehicle 2. When arranged in opening 4, the flange 21 can extend downwards from the lower edge 20 of the closing plate 8. The flange 21 may be configured to at least partially rest against the exterior 23 of the vehicle 2. The exterior 23 may for example be the exterior 23 of the passenger door or the door on the driver's side of the vehicle 2. The vehicle 2 may have a slot 24 for the glass pane, where the glass pane of the window or opening 4 is arranged to be lowered into the slot 24. Preferably the flange 21 is configured to be arranged at least partially outside relative to the glass pane slot 24 of the vehicle 2 when the closing plate 8 is arranged in the opening 4. The flange 21 may cover a part of the glass pane slot 24. One purpose of the flange 21 is to prevent water to enter the cabin or the glass pane slot 24. The flange 21 may be configured to lead water away from the surface of the second side 19 of the closing plate 8 and onto the exterior 23 of the vehicle. Water, such as rain, will follow the surface of the second side 19 of the closing 8 plate and run down on the exterior 23 of the vehicle 2.

In some embodiments, the flange 21 has a flange lower edge 29 that is below the lower edge 7 of the opening 4 of the vehicle 2, when the device 1 is arranged in the opening 4.

In some embodiments, a part of the lower edge 20 has a downward-facing groove 25 arranged to receive the lower edge 7 of the opening of the vehicle 2. The flange 21 may form a part of the groove 25 and an example of this is shown in FIG. 8. The groove 25 may be configured to rest on the lower edge 7. The groove 25 assists in keeping the closing plate 8 in position in the opening 4.

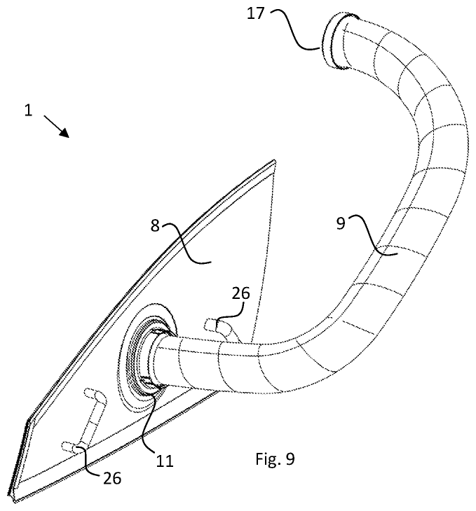

The embodiments of the device 1 of FIG. 9 do not have an inlet 14 for attaching to a HVAC outlet 13 or hose 9a on the first side 19 of the closing plate 8. The closing plate 8 has a second side 19 and aperture 10, and an air conduit 9 from the aperture 10 to a device outlet 17. In use, the HVAC system 12 provides heated or cooled air from the cabin of the vehicle 2 through the aperture 10 to the conduit 9 to the device outlet 17.

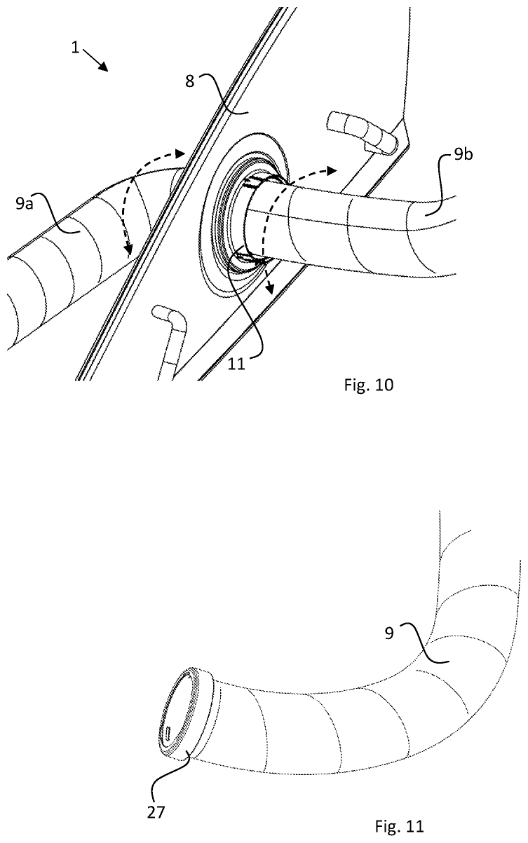

With reference to FIGS. 10 and 11, in various embodiments the air conduit 9 comprises a first conduit part 9a from the inlet 14 to the closing plate 8 or a second conduit part 9b from the closing plate 8 to the device outlet 17 (or both conduit parts 9a and 9b), and where the first or second conduit part 9a, 9b is rotatably attached to the closing plate 8. The first or second conduit parts 9a, 9b are hence able to rotate along their longitudinal axis, as shown with the dashed arrows in FIG. 10. This is advantageous because it prevents the formation of kinks on the conduit 9a, 9b, when installing and using the device 1. In a preferred embodiment both conduit parts 9a and 9b are rotatably attached to the closing plate 8. Preferably first and second conduit parts 9a, 9b are able to rotate independently of each other. Preferably a conduit part 9a, 9b is able to rotate freely in respect of the closing plate 8.

An end of a conduit part may have an attachment ring 27 for attachment to the attachment device of the closing plate 8, which may be a sleeve 11 as shown in FIGS. 10 and 11, where the attachment ring 27 is able to rotate in the sleeve 11. The attachment ring 27 may attach to the attachment device of the closing plate 8 for example with a snap lock and in FIG. 3 each side of the sleeve 11 comprises at least one flexible hook 28a and 28b that interacts with ring 27 in a locking and reversible manner. A user may disengage conduit 9a or 9b by pressing the hook 28a or 28b.

In some embodiments a conduit part 9a or 9b is reversibly or removably attached to the closing plate 8, for example with a snap lock. The ends of the conduit parts 9a 9b are hence preferably reversibly attached to the attachment device of the closing plate 8 for example with a snap lock as shown in FIGS. 3 and 10-11. This facilitates disassembly and storage of the device 1.

A method for providing heating or cooling to a living space 3 may comprise the steps of arranging a device 1 in an opening of a vehicle 2 and providing the device outlet 17 to the living space 3, and running the HVAC system 12 of the vehicle 2 to provide heated or cooled air to the living space 3. If the device 1 has an inlet 14 and an air conduit 9a from the inlet 14, the method also involves the step of connecting the inlet 14 to a HVAC outlet 13. When opening 4 has a window the method comprises the step of at least partially opening the window, for example by lowering a glass pane. It may be preferred that the device 1, in particular the closing plate 8, is configured to be inserted in an opening 4 that is created when the window is completely open, for example when the glass pane has been lowered completely into the door. In other embodiments, the device 1 is configured to be arranged in a window that is partly opened, for example where the glass pane has been party lowered. The window may be adjusted to fit the size of the closing plate 8. The method may comprise the step of arranging the device 1 such that the flange 21 or the groove 25 is at least partially covering the pane slot 24. The method may comprise the step of arranging the device 1 so that the flange 21 at least partially rests on the exterior 23 of the vehicle 2.

If the HVAC system 12 of the vehicle 2 has a plurality of HVAC outlets 13 and the HVAC system 12 can be arranged so that the heated or cooled air only comes from one of the HVAC outlets 13, the method may comprise the step of adjusting the HVAC system 12 so that heated or cooled air is provided only from the HVAC outlet 13 to which the inlet 14 is connected. In some embodiments, where the HVAC system 12 has a plurality of outlets 13, a user may be able to select one single HVAC outlet 13 for providing heated or cooled air. In some embodiments the selected HVAC outlet 13 may be arranged on the passenger side or the driver's side of a car. This is the case in for example various Tesla models, where all air can be directed to a HVAC outlet on the driver's side.

It is realized that everything which has been described in connection to one embodiment is fully applicable to other embodiments, as compatible. Hence, the invention is not limited to the described embodiments, but can be varied within the scope of the enclosed claims. While the invention has been described with reference to specific exemplary embodiments, the description is in general only intended to illustrate the inventive concept and should not be taken as limiting the scope of the invention. The invention is generally defined by the claims.

### Clauses

Various embodiments may be claimed as follows:
1. A device comprising
   a closing plate configured to be arranged in an opening from a cabin of a vehicle to the exterior of the vehicle, said opening of the vehicle having a lower edge,
   the window closing plate having an aperture and an air conduit from the aperture to a device outlet, and where the closing plate has a lower edge configured to be arranged along the lower edge of the opening and characterized in that the lower edge of the closing plate has a flange with an outer surface that is continuous with the surface of the closing plate, said flange being configured to cover a part of the exterior of the vehicle.
2. The device according to clause 1 where the flange is configured to lead water away from the surface of the surface of the closing plate and onto the exterior of the vehicle.
3. The device according to clause 1 or 2 where a part of the lower edge of the closing plate has a downward-facing groove arranged to receive the lower edge of the opening of the vehicle, where the flange forms a part of the groove.
4. The device according to any one of clauses 1 to 3 where the air conduit comprises a first conduit part from a device inlet to the closing plate or a second conduit part from the closing plate to the device outlet.
5. The device according to any one of clauses 1 to 4 and where a conduit part is rotatably attached to the closing plate.
6. The device according to any one of clauses 1 to 5 where a conduit part is reversibly attached to the closing plate.
7. A method for providing heating or cooling to a living space involving a device according to any one of clause 1 to 6,
the method involving a vehicle with a cabin and a HVAC system for providing heated or cooled air to the cabin the cabin having an opening to the exterior, said HVAC system having at least one HVAC outlet,
the method comprising
arranging the closing plate in the opening,
providing the device outlet to the living space,
running the HVAC system of the vehicle to provide heated or cooled air into the cabin of the vehicle, so that the device outlet of the air conduit provides heated or cooled air to the living space.
8. The method according to clause 7 where the vehicle is an electric vehicle.

1. A device comprising,
an inlet configured to attach to a HVAC outlet in a cabin of a vehicle,
a closing plate configured to be arranged in an opening from the cabin of the vehicle to the exterior of the vehicle,
an air conduit arranged to provide air from the inlet through an aperture in the closing plate, to a device outlet.

2. The device according to claim 1 wherein the inlet is configured to reversibly attach to the HVAC outlet with a snap fit, friction fit, or an interference fit.

3. The device according to claim 1, wherein the air conduit comprises a first conduit part from the inlet to the closing plate and a second conduit part from the closing plate to the device outlet, and where the first or second conduit part is rotatably attached to the closing plate.

4. The device according to claim 1, wherein the air conduit comprises a first conduit part from the inlet to the closing plate and a second conduit part from the closing plate to the device outlet and where the first or second conduit part is reversibly attached to the closing plate.

5. The device according to claim 1, wherein the device comprises a sleeve at least partly arranged in the aperture of the closing plate, and wherein the air conduit comprises a first conduit part from the inlet to the aperture in the closing plate and a second conduit part from the aperture in the closing plate to the device outlet and wherein the first or second conduit part is reversibly attached to the sleeve.

6. The device according to claim 1, wherein the closing plate has a first side and a second side, wherein the closing plate is configured to be arranged in an opening from a cabin of the vehicle to the exterior of the vehicle wherein the opening has a lower edge and wherein the closing plate has a lower edge configured to be arranged along the lower edge of the opening and characterized in that the lower edge of the closing plate has a flange configured to cover a part of the exterior of the vehicle.

7. The device according to claim 5, wherein the flange is configured to lead water away from the surface of the closing plate and onto the exterior of the vehicle.

8. The device according to claim 5, wherein a part of the lower edge has a downward-facing groove arranged to receive the lower edge of the opening of the vehicle, where the flange forms a part of the groove.

9. A method for providing heating or cooling to a living space using a device according to claim 1, the method involving a vehicle with a cabin and a HVAC system for providing heated or cooled air to the cabin, the cabin having an opening to the exterior, said HVAC system having at least one HVAC outlet,
the method comprising:
arranging the closing plate in the opening,
connecting the inlet to a HVAC outlet,
providing the device outlet to the living space, and
running the HVAC system of the vehicle to provide heated or cooled air to the living space.

10. The method of claim 9 where the HVAC system of the vehicle has a plurality of HVAC outlets and where the HVAC system is controlled so that heated or cooled air is provided only from the HVAC outlet to which the inlet is connected.

11. The method of claim 9 where the vehicle is an electric vehicle.
